(19) United States
(12) Patent Application Publication
(10) Pub. No.: US 2013/0192303 A1
(43) Pub. Date: Aug. 1, 2013

(54) QUALITATIVE CRYSTAL DEFECT EVALUATION METHOD

(71) Applicant: Jae Woo Ryu, Chesterfield, MO (US)

(72) Inventors: Jae Woo Ryu, Chesterfield, MO (US); Pil Yeong Hong, Cheonan (KR)

(73) Assignee: MEMC, St. Peters, MO (US)

(21) Appl. No.: 13/359,645

(22) Filed: Jan. 27, 2012

(51) Int. Cl. G01N 21/17

(52) U.S. Cl. CPC G01N 21/17
USPC 65/29.12; 65/60.4; 65/31

(57) ABSTRACT

A process is provided for evaluating oxygen precipitates in a single crystal silicon sample. The process comprises (a) annealing the single crystal silicon sample at a temperature sufficient to selectively grow as-grown oxygen precipitates having a size of about 25 nm or more and selectively dissolve as-grown oxygen precipitates having a size of about 25 nm or less; (b) cooling the single crystal silicon sample at a cooling rate sufficient to inhibit the nucleation of oxygen precipitates having a size of about 25 nm or less; (c) coating a surface of the single crystal silicon sample with a composition containing a metal capable of decorating oxygen precipitates; and (d) annealing the coated single crystal silicon sample at a temperature, for a duration, and in an atmosphere sufficient to decorate the oxygen precipitates in the single crystal silicon sample.

### FIELD OF THE INVENTION

The present invention is directed to a method for the qualitative evaluation of agglomerated intrinsic point defects in single crystal silicon. More specifically, the present invention is directed to the qualitative evaluation of large size as-grown precipitate zone and small size as-grown precipitate zone in the Perfect Vacancy region and OSF ring zone in the P-band.

### BACKGROUND OF THE INVENTION

Single crystal silicon, which is the starting material for most processes for the fabrication of semiconductor electronic components, is commonly prepared by the so-called Czochralski (“Cz”) method. In this method, polycrystalline silicon (“polysilicon”) is charged to a crucible and melted, a seed crystal is brought into contact with the molten silicon and a single crystal is grown by slow extraction. After formation of a neck is complete, the diameter of the crystal is enlarged by decreasing the pulling rate and/or the melt temperature until the desired or target diameter is reached. The cylindrical main body of the crystal which has an approximately constant diameter is then grown by controlling the pull rate and the melt temperature while compensating for the decreasing melt level. Near the end of the growth process but before the crucible is emptied of molten silicon, the crystal diameter must be reduced gradually to form an end-cone. Typically, the end-cone is formed by increasing the crystal pull rate and heat supplied to the crucible. When the diameter becomes small enough, the crystal is then separated from the melt.

In recent years, it has been recognized that a number of defects in single crystal silicon form in the crystal growth chamber as the crystal cools after solidification. Such defects arise, in part, due to the presence of an excess (i.e., a concentration above the solubility limit) of intrinsic point defects, which are known as vacancies and self-interstitials. Silicon crystals grown from a melt are typically grown with an excess of one or the other type of intrinsic point defect, either crystal lattice vacancies (“V”) or silicon self-interstitials (“I”). It has been suggested that the type and initial concentration of these point defects in the silicon are determined at the time of solidification and, if these concentrations reach a level of critical supersaturation in the system and the mobility of the point defects is sufficiently high, a reaction, or an agglomeration event, will likely occur. Agglomerated intrinsic point defects in silicon can severely impact the yield potential of the material in the production of complex and highly integrated circuits. The density of such vacancy and self-interstitial agglomerated defects in Czochralski silicon is conventionally within the range of about 1×10³/cm³ to about 1×10⁷/cm³. While these values are relatively low, agglomerated intrinsic point defects are of rapidly increasing importance to device manufacturers and, in fact, are now seen as yield-limiting factors in device fabrication processes.

Vacancy-type defects are recognized to be the origin of such observable crystal defects as D-defects, Flow Pattern Defects (FPDs), Gate Oxide Integrity (GOI) Defects, Crystal Originated Particle (COP) Defects, crystal originated Light Point Defects (LPDs), as well as certain classes of bulk defects observed by infrared light scattering techniques such as Scanning Infrared Microscopy and Laser Scanning Tomography. Defects relating to self-interstitials are less well studied. They are generally regarded as being low densities of interstitial-type dislocation loops or networks. Such defects are not responsible for gate oxide integrity failures, an important wafer performance criterion, but they are widely recognized to be the cause of other types of device failures usually associated with current leakage problems.

In regions of excess vacancies are defects which act as the nuclei for ring oxidation induced stacking faults (OISF). It is speculated that this particular defect is a high temperature nucleated oxygen agglomerate catalyzed by the presence of excess vacancies. As integrated circuit devices have decreased in size, it has been recognized that grown-in oxygen precipitates and the formation of a ring or core pattern of oxidation induced stacking fault (OISF) in a single crystal silicon sample is an increasingly important defect in the device manufacturing process. Device manufacturers have reported that oxygen precipitates in the perfect silicon region of a silicon single crystal wafer may cause current leakage in advanced device lines such as the 22 nm node. This reliability problem may be associated with further growth of oxygen precipitates during the device manufacturing process.

OISF and oxygen precipitates are typically formed in the silicon single crystal as long as crystal growth conditions are not extremely larger than the critical V/Gₒ (where V is crystal growth speed and Gₒ is axial temperature gradient at solid/liquid interface) or is within the critical V/Gₒ range. Since the radial position of the OISF ring or core is dependent on V/Gₒ, an extremely high growth speed and V/Gₒ pushes OISF ring to the single crystal ingot surface. Meanwhile, a slow growth speed and resultant smaller V/Gₒ than the critical value shrinks the OISF ring or core to the crystal center. See U.S. Pat. No. 6,840,997 (Falster et al.; assigned to MEMC Electronic Materials, Inc. of St. Peters, Mo.). Extremely low growth speed generates B and A-defects. In general, the types of defects that form during single crystal silicon growth as a function of V/Gₒ are as shown (from high V/Gₒ to low V/Gₒ):

Full vacancy without OiSF>Vacancy dominant with OiSF ring or core>Perfect Silicon>A/B-defect

Extremely high V/Gₒ corresponds to a full vacancy dominant crystal having COP (Crystal originated particle such as FPD (Flow Patten Defect), DSOD (Direct Surface Oxide Defect), LSTD (Laser Scattering Tomography Defect)) through the entire radial position of crystal. Perfect Silicon through the entire radial position of wafer requires V/Gₒ control within a specific range. An OISF ring or core is formed in the wafer during thermal process involved in device manufacture, if the V/Gₒ falls between these two ranges. Thus, the Perfect Silicon process seeks to eliminate OSF ring or core during silicon single crystal growth. To confirm whether grown silicon single crystal is free from an OISF ring or core and to confirm the radial position of OISF ring or core, the sample wafer is generally evaluated by specific methods prior to wafer fabrication.

Various metrology techniques have been developed to attempt to clearly resolve the location of the P-band (i.e., the location of the OISF ring or core) and the large as-grown precipitate zone of Perfect Silicon vacancy side. The techniques known in the art require time consuming evaluation processes, which is detrimental to device throughput. Additionally, known techniques in the art are incapable of delineating a large as-grown oxygen precipitate region from a small as-grown oxygen precipitate region in the Perfect Vacancy (Pv) region.

### BRIEF DESCRIPTION OF THE INVENTION

Briefly, therefore, the present invention is directed to a process for evaluating oxygen precipitates in a single crystal silicon sample. The process comprises (a) annealing the single crystal silicon sample at a temperature sufficient to selectively grow as-grown oxygen precipitates having a size of about 25 nm or more and selectively dissolve as-grown oxygen precipitates having a size of about 25 nm or less; (b) cooling the single crystal silicon sample at a cooling rate sufficient to inhibit the nucleation of oxygen precipitates having a size of about 25 nm or less; (c) coating a surface of the single crystal silicon sample with a composition containing a metal capable of decorating oxygen precipitates; and (d) annealing the coated single crystal silicon sample at a temperature, for a duration, and in an atmosphere sufficient to decorate the oxygen precipitates in the single crystal silicon sample.

### BRIEF DESCRIPTION OF THE DRAWINGS

FIG. 1 is a depiction of various defect zones in a single crystal silicon ingot.

FIG. 2 is a photograph of wafer quarters prepared according to the methods described in Examples 1-4.

FIG. 3 is a depiction of a furnace muffler.

FIG. 4 is a photograph of a wafer prepared according to the method described in Example 5.

FIG. 5 is a photograph of a wafer prepared according to the method described in Example 6.

FIG. 6 is a photograph of a wafer prepared according to the method described in Example 7.

FIG. 7 is a photograph of a wafer prepared according to the method described in Example 8.

FIG. 8 is a photograph of a wafer prepared according to the method described in Example 9.

FIG. 9 is a photograph of a wafer prepared according to the method described in Example 10.

FIG. 10 is a photograph of a wafer prepared according to the method described in Example 11.

### DETAILED DESCRIPTION OF THE EMBODIMENT(S) OF THE INVENTION

The present invention is directed a method for the qualitative evaluation of agglomerated intrinsic point defects in single crystal silicon. More specifically, the present invention is directed to the qualitative evaluation of oxygen precipitate zones in the Perfect Vacancy region and the evaluation of the oxidation induce stacking fault zone in the P-band of single crystal silicon. The method of the present invention enables the resolution of as-grown small size oxygen precipitates, as-grown large size oxygen precipitates, and oxidation induced stacking faults by temperature control (annealing and cooling) for selective dissolution and selective controlled growth of as-grown defects.

Substrates for qualitative evaluation according to the method of the present invention are generally monocrystalline silicon substrates. In general, the monocrystalline silicon substrate comprises two major, generally parallel surfaces, one of which is a front surface of the substrate and the other of which is a back surface of the substrate, a circumferential edge joining the front and back surfaces, and a central plane between the front and back surfaces. Prior to any operation as described herein, the front surface and the back surface of the substrate may be substantially identical. A surface is referred to as a “front surface” or a “back surface” merely for convenience and generally to distinguish the surface upon which the operations of method of the present invention are performed. This naming convention does not exclude carrying out identical such operations, or different operations, on the back surface of the donor substrate.

In some embodiments, the monocrystalline silicon substrate comprises a segment of a single crystal silicon ingot. In some embodiments, the monocrystalline silicon substrate comprises a single crystal silicon wafer. In particularly preferred embodiments, the silicon wafer comprises a wafer sliced from a single crystal silicon wafer which has been sliced from a single crystal ingot grown in accordance with conventional Czochralski crystal growing methods. The single crystal silicon ingot has a nominal diameter achievable by Czochralski crystal growing methods. In general, the nominal diameter may be at least about 150 mm, about 200 mm, or greater than about 200 mm, such as 250 mm, 300 mm or even 450 mm. Ingot growth as well as standard silicon slicing, lapping, etching, and polishing techniques are disclosed, for example, in F. Shimura, Semiconductor Silicon Crystal Technology, Academic Press, 1989, and Silicon Chemical Etching, (J. Grabmaier ed.) Springer-Verlag, N.Y., 1982 (incorporated herein by reference).

Based upon experimental evidence to date, it appears that the type and initial concentration of intrinsic point defects in a monocrystalline silicon substrate is initially determined as the single crystal silicon ingot cools from the temperature of solidification (i.e., about 1410° C.) to a temperature greater than about 1300° C. (i.e., at least about 1325° C., at least about 1350° C. or even at least about 1375° C.). That is, the type and initial concentration of these defects are controlled by the ratio v/Gₒ, where v is the growth velocity and Gₒ is the average axial temperature gradient over this temperature range.

For increasing values of v/Gₒ, a transition from decreasingly self-interstitial dominated growth to increasingly vacancy dominated growth occurs near a critical value of v/Gₒ which, based upon currently available information, appears to be about 2.1×10⁻⁵ cm²/sK, where Gₒ is determined under conditions in which the axial temperature gradient is constant within the temperature range defined-above. At this critical value, the concentrations of these intrinsic point defects are at equilibrium.

As the value of v/Gₒ exceeds the critical value, the concentration of vacancies increases. Likewise, as the value of v/Gₒ falls below the critical value, the concentration of self-interstitials increases. If these concentrations reach a level of critical supersaturation in the system, and if the mobility of the point defects is sufficiently high, a reaction, or an agglomeration event, will likely occur. Agglomerated intrinsic point defects in silicon can severely impact the yield potential of the material in the production of complex and highly integrated circuits. Control of the initial type and quantity of intrinsic points defects has been disclosed in, e.g., U.S. Pat. No. 6,840,997 (Falster et al.; assigned to MEMC Electronic Materials, Inc. of St. Peters, Mo.), or U.S. patent application Ser. No. 11/750,706 (Kulkarni; assigned to MEMC Electronic Materials, Inc. of St. Peters Mo.), the disclosures of which are hereby incorporated by reference for all relative and consistent purposes as if set forth in its entirety. It should be noted that the critical value of v/Gₒ for a particular growth process may alternatively be calculated based on the corrected and/or effective values as described in U.S. patent application Ser. No. 11/750,706 without departing from the scope of the present invention.

Ingots prepared by the Czochralski method generally contain oxygen impurities, which may enter the silicon melt from the ambient atmosphere and from the crucible wall. During crystal growth, the molten silicon etches or dissolves the quartz that makes up the crucible, thereby generating oxygen doping. The oxygen is dispersed throughout the crystal and can cluster to form precipitates and complexes. Single crystal silicon ingots may comprise oxygen concentrations up to about 30 PPMA (parts per million atomic, ASTM standard F-121-83 or SEMI standard M44), and generally less than about 20 PPMA. In preferred embodiments of the present invention, the oxygen concentration is generally no greater than about 14 PPMA oxygen, such as less than about 13 PPMA, more preferably, the single crystal silicon contains less than about 12 PPMA oxygen, still more preferably less than about 11 PPMA oxygen, and most preferably less than about 10 PPMA oxygen. In some embodiments, the oxygen concentration may vary from about 6 PPMA to about 13 PPMA. The formation of stacking faults is strongly dependent upon the content of interstitial oxygen in the monocrystalline silicon substrate. OISFs are not well detected if the oxygen concentration is less than a certain level, generally less than about 12 PPMA. The method of the present invention enables resolution of as-grown small size oxygen precipitates, as-grown large size oxygen precipitates, and OISF in single crystal silicon substrates having low oxygen concentrations, such as between 6 PPMA and 13 PPMA.

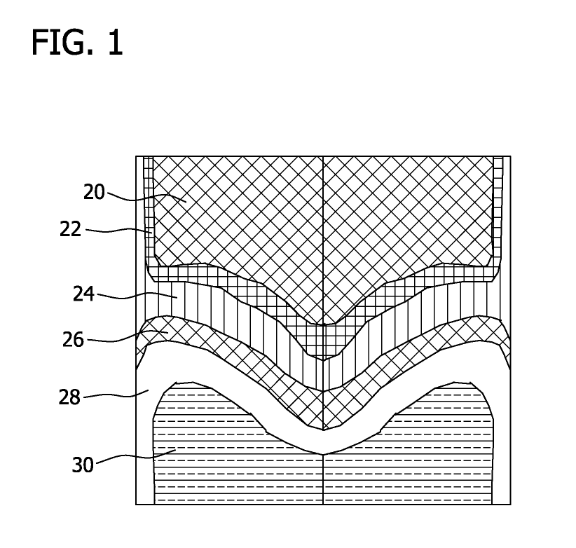

With reference now to FIG. 1, zones of various as-grown defects may be depicted in a section of a single crystal silicon ingot 10 with certain defect regions enumerated, including the crystal originated pit (COP) region 20, the region 22 in which oxidation induced stacking faults (OISF) may form during device manufacture (i.e., the P band), the as-grown large size oxygen precipitate region 24 in the Perfect Vacancy (Pv) region, the as-grown small size oxygen precipitate region 26 in the Perfect Vacancy (Pv) region, a Perfect Interstitial (Pi) region 28, and an A-defect region 30.

Nucleation and growth of oxygen precipitates in the perfect vacancy are governed by the concentration of oxygen, vacancies, and interstitial silicon within the silicon single crystal ingot and by the temperature and cooling rate, if there are no additional contributing factors, such as impurities (e.g., metals, carbon, and the like). Oxygen precipitates may be characterized as small size as grown precipitates or large size as grown precipitates. In general, oxygen precipitates smaller than about 25 nm are considered small size while those large than about 25 nm are considered large size. Small size and large size oxygen precipitates may also differ based on their crystallographic properties. Small size oxygen precipitates usually have an amorphous structure, while large size oxygen precipitates tend towards crystallization.

In vacancy dominant single crystal silicon, oxygen precipitates nucleate and form at a temperature range between about 1200° C. and about 1250° C. and grow continuously. In general, such nucleation and growth tends to continue until the crystal cools to a temperature generally below about 1000° C. Oxygen precipitation and growth is diffusion controlled, so at temperatures generally below about 1000° C., vacancy diffusion generally slows to a point that no longer supports further nucleation of oxygen precipitates. The vacancy concentration is generally the limiting factor in the nucleation and size of oxygen precipitates. In regions of high vacancy concentration, large oxygen precipitates tend to form. If the vacancy dominant region lacks the vacancies to growth large oxygen precipitates, small oxygen precipitates generally dominate.

Defects present in the OSF region, i.e., the P band, are relatively large size oxygen precipitates that nucleate and grow rapidly in the temperature range of about 1200° C. to about 1250° C. due to the substantial excess of vacancies provided in the OSF region. The oxygen precipitates tend to be no greater than about 40 nanometers as the ingot cools to about 1100° C., during which COP formation occurs. A continuous and sufficient supply of excess vacancy enables oxygen precipitates in the P band to grow until the ingot temperature cools to a temperature that limits vacancy diffusion. The oxygen precipitates herein undergo a shape transition from octahedral to platelet at around 950° C. to minimize the surface energy in the interface between the silicon matrix and the precipitate. The temperature of this transition varies depending upon the size of the precipitate and excess vacancy concentration near the precipitate. If its diagonal size is larger than critical, a nuclei of stacking fault is formed by dislocation-loop punching at the temperature between about 900° C. to about 950° C. The P band thus comprises large oxygen precipitates with or without dislocation loops and stacking fault nuclei.

The method of the present invention is particularly directed to delineating and resolving as-grown small size oxygen precipitates 24, as-grown large size oxygen precipitates 26, and the oxidation induced stacking fault (OISF) region 22. A thermal process, such as those which a silicon wafer is subjected during device manufacture, may cause the formation of oxidation induced stacking faults, generally in the P-band, which comprises larger oxygen precipitates and nuclei of stacking fault. OISFs grow in particular in ambient atmospheres which cause the injection of self-interstitial atoms into bulk silicon. In general, as-grown small size oxygen precipitates include those having a transverse dimension, such as a diameter assuming the precipitate is generally spherical, of less than about 25 nanometers, more generally less than about 20 nanometers. In general, as-grown large size oxygen precipitates include those having a transverse dimension, such as a diameter assuming the precipitate is generally spherical, of less than about 75 nanometers, more generally less than about 65 nanometers, and larger than about 25 nanometers, such as about 30 nanometers. Oxidation induced stacking faults are generally larger defects having a transverse dimension, such as a diameter assuming the stacking fault is generally spherical, that is greater than about 70 nanometers, greater than about 75 nanometers, or greater than about 80 nanometers.

The present invention is therefore directed to a process for evaluating and delineating defects related to oxygen precipitation in a single crystal silicon sample. The method of the present invention enables the resolution of as-grown small size oxygen precipitates from as-grown large size oxygen precipitates and also enables the resolution of Perfect Vacancy silicon, which tends to contains small and large oxygen precipitates, from the P-band, which additionally contains nuclei of stacking faults, which may form OISF during a device manufacturing process. Stated another way, the method of the present invention enables the qualitative analysis of the size of oxygen precipitates in a single crystal silicon wafer, which enables the determination of whether a wafer contains generally small size oxygen precipitates, which generally dissolve or grow very slowly in a device manufacturing process, or whether the wafer contains large size oxygen precipitates and stacking fault nuclei, which may form OISF during a manufacturing process, or whether the wafer contains zones of both such precipitates. The process of the present invention thereby enables sorting of wafers according to defect identity and size.

The method of the present invention includes a step of annealing an etched and/or polished single crystal silicon sample, more specifically a segment of a single crystal silicon ingot grown by the Czochralski method, e.g., a slug or wafer, preferably a wafer. The single crystal silicon wafer is annealed at a temperature in which as-grown small size oxygen precipitates generally dissolve, shrink in size, or at least do not grow substantially. That is, the temperature of the anneal combined with other parameters such as the ambient atmosphere is such that oxygen precipitates having a size of about 25 nm or less advantageously dissolve or shrink in size. The temperature, ambient atmosphere, etc. are controlled to cause the growth of as-grown large size oxygen precipitates (e.g., having a size of about 25 nm or more) to grow and, in some cases, form into oxidation induced stacking faults.

Annealing temperatures which enable the selective growth of as-grown large size oxygen precipitates and concurrent shrinking or dissolution of as-grown small size oxygen precipitates are generally at least about 1100° C., preferably at least about 1200° C. In some embodiments, the anneal temperature is about 1100° C. In some embodiments, the anneal temperature is about 1200° C. In some embodiments, the anneal temperature is between about 1220° C. and about 1260° C. Minimum temperatures above about 1100° C., such as from about 1100° C. to about 1200° C., mimic temperatures at which oxygen precipitates nucleate and grow during crystal growth, particularly during the cooling of the solidified ingot. The high temperature anneal causes oxygen precipitates in the vacancy perfect region to grow to a larger size.

The anneal step of the method of the present invention seeks to avoid, as much as possible, wafer residence times in temperatures within the range of temperatures in which small oxygen precipitates may nucleate and grow, e.g., by the diffusion of vacancies within the as-grown small size oxygen precipitate region 26 or even from the as-grown large size oxygen precipitate region 24. Accordingly, the wafer is rapidly heated through a temperature range below about 600° C., preferably below about 500° C., to the anneal temperature of at least about 1100° C., preferably at least about 1200° C. Such rapid heating is preferably at a heating rate of at least about 5° C./minute, more preferably at least about 7° C./minute. Some furnaces enable heating at temperature ramps as steep as at least about 20° C./minute. Certain instrumentation, such as rapid thermal annealers, enables even steeper temperature ramps, such as at least about 1° C./second. Very fast rates may cause wafer slip, so the heating temperature rate may generally be between about 5° C./minute and about 20° C./minute, such as between about 5° C./minute and about 10° C./minute. Rapidly increasing the temperature from a relatively low temperature to the temperature of the anneal advantageously minimizes the duration at which the single crystal silicon samples spend in the temperature range at which small oxygen precipitates may grow. Accordingly, the effect of the temperature ramp and anneal has minimal effect on the size and number of small oxygen precipitates in the wafer. That is, the concentration and size of such small oxygen precipitates during the temperature ramp remains essentially the same as the concentration and size of these precipitates in the wafer when it was sliced from the cooled ingot. Upon achieving temperatures in excess of 1100° C., the wafer is annealed at a temperature sufficient to shrink or even dissolve such small oxygen precipitates.

The effect of the temperature ramp and the anneal on the as-grown large size oxygen precipitates differs from the effect on the small oxygen precipitates. Small oxygen precipitates, e.g., less than about 25 nm or even less than about 20 nm, generally dissolve during the anneal. If the oxygen precipitates are larger than critical size, generally greater than about 25 nm, these precipitates grow during the anneal. The growth of small size oxygen precipitates is further limited by the region in which these precipitates tend to form, which has little to no excess vacancies to support precipitate growth. The temperature ramp and anneal temperature thus preferentially grow the large precipitates. In the region of large size oxygen precipitates, the vacancy concentration is sufficient to enable the additional growth of the large size oxygen precipitates, thereby causing these to increase in size during the anneal. The size differential between small precipitates and large precipitates is increased by the dissolution of small size oxygen precipitates and the growth of the large size oxygen precipitates. In this regard, the anneal duration preferably allows sufficient time for such growth of the large oxygen precipitates. In the P-band, the stacking fault nuclei and large size precipitates therein may also grow during the anneal, wit additional nuclei forming after the anneal is over and the wafer is cooled through temperatures below about 1000° C., such as between about 900° C. and about 950° C. Preferably, the anneal duration is at least about 180, preferably at least about 300 seconds, even more preferably between about 300 seconds and about 20 minutes.

The anneal preferably occurs in an oxidizing environment. An oxygen gas ambient for annealing provides dissolution advantages of the rapid high temperature treatment. Specifically, annealing in oxygen injects silicon self-interstitials from the surface of the single crystal silicon sample, thereby changing the point defect balance to self-interstitials and suppressing the build-up of vacancies in the bulk of the sample. The ambient atmosphere may comprise an oxidizing gas such as oxygen in combination with an inert gas, such as argon gas. In some embodiments, the annealing environment may include a nitrogen-containing gas, such as nitrogen or ammonia. The annealing environment may also include hydrogen gas. According to the method of the present invention, the ambient atmosphere does not need pressure control. Preferably, the ambient atmosphere is flow rate controlled such that the flow rate of oxidizing gas, e.g., oxygen, enters the chamber in which the anneal occurs at a flow rate of at least about 1 standard liter per minute (SLPM), such as at least about 1.5 SLPM, or at least about 2 SLPM.

The anneal may occur in any apparatus capable of holding at least one, preferably multiple single crystal silicon samples in a manner in which at least the front surface of the sample is exposed to the ambient atmosphere. Suitable apparatuses include a muffle furnace or a tube furnace. Such furnaces may be obtained from ThermVac Engineering (South Korea), which manufactures furnaces capable of achieving temperatures in excess of 1400° C.

After annealing for a sufficient duration to selectively grow the as-grown large size oxygen precipitates, the single crystal silicon sample is rapidly cooled to a temperature below about 600° C., preferably below about 500° C. Preferably, the sample is cooled at a high rate, such as at least about 5° C./minute, preferably at least about 7° C./minute, to avoid residence times in temperatures that allow vacancy diffusion that may result in the growth of small size oxygen precipitates. Some furnaces enable cooling at temperature ramps as steep as at least about 20° C./minute. Certain instrumentation, such as rapid thermal annealers, enables even steeper cooling temperature ramps, such as at least about 1° C./second. Very fast cooling rates may cause wafer slip, so the cooling temperature rate may generally be between about 5° C./minute and about 20° C./minute, such as between about 5° C./minute and about 10° C./minute. Rapid cooling is preferred for substantially the same reasons that rapid heating is preferred.

The selectively grown large size oxygen precipitates and oxidation induced stacking faults may be detected by a number of different techniques. According to the method of the present invention, defects on the surface of the single crystal silicon sample may be visually detect by decorating these defects with a metal capable of diffusing into the single crystal silicon matrix upon the application of heat. Specifically, single crystal silicon samples, such as wafers, slugs or slabs, may be visually inspected for the presence of such defects by first coating a surface of the sample with a composition containing a metal capable of decorating these defects. In some embodiments, the samples are coated with a concentrated solution of a copper salt, preferably copper nitrate. Either the front surface or the back surface of the sample may be coated. For thin samples, e.g., wafers, preferably the back surface of the sample is coated. The coated sample is then dried, generally at a temperature between about 50° C. and about 100° C. Thereafter, the coated sample is annealed at a temperature between about 900° C. and about 1000° C. for at least about 300 seconds, preferably between about 300 seconds and about 20 minutes in order to diffuse the metal into the sample. The heat treated sample is then cooled to room temperature, preferably rapidly, thus causing the metal to become critically supersaturated and precipitate at sites within the sample matrix at which defects are present. During this anneal, both small and large precipitates may grow in size. However, an as-cut silicon sample typically contains small size and large size precipitates with relatively small differential of precipitate size between small and large so most of precipitates are decorated by the saturated copper solution. However, commonly none of the precipitates are visible in the Perfect Vacancy (L-band) region since both small and large precipitates are generally too small to be visible by Cu-decorating, even if they are grown by this anneal. The process of the present invention, however, includes a high temperature anneal that differentiates the small size oxygen precipitates and the large size oxygen precipitates by preferentially growing large size precipitates while dissolving or retarding the growth of small size oxygen precipitates. The large size oxygen precipitates in the Perfect Vacancy (L-band) region decorated by copper become visible to inspection.

After cooling, the sample is first subjected to a non-defect delineating etch, in order to remove surface residue and precipitants. In some embodiments, the sample is treated in a non-defect delineating bright etch solution or a mixed acid etch solution for about 8 to about 12 minutes. An exemplary bright etch solution comprises between about 50 percent nitric acid to about 57 percent nitric acid (70% solution by weight), between about 16 and about 20 percent hydrofluoric acid (49% solution by weight), and between about 20 percent and about 25 percent hydrochloric acid (concentrated solution).

The sample is then rinsed with deionized water and subjected to a second etching step by immersing the sample in, or treating it with, a Secco or Wright etch solution for about 35 to about 55 minutes. Typically, the sample will be etched using a Secco etch solution comprising about a 1:2 ratio of 0.15 M potassium dichromate and hydrofluoric acid (49% solution by weight). This etching step acts to reveal, or delineate, agglomerated defects which may be present.

The etched sample is then visually inspecting for the presence of decorated oxygen precipitates, preferably under bright light. As well as visual inspection for crystal defects, the single crystal silicon sample may be photographed using an optical camera in bright light. Although the density and size of crystal defects are not quantitatively measured by this technique, the photograph from copper decoration provides qualitative data for crystal defect zone. A photograph may be compared to a scale to measure the size and position of crystal defect zone quantitatively. Visual and quantitative inspection enables sorting of silicon wafers according to defect type.

Having described the invention in detail, it will be apparent that modifications and variations are possible without departing from the scope of the invention defined in the appended claims.

The following non-limiting examples are provided to further illustrate the present invention.

### EXAMPLE 1

### Copper Decoration of Silicon Wafer

Copper decoration was carried out on a silicon wafer sample. The silicon wafer sample was etched and polished according to conventional techniques. A saturated solution of copper nitrate (Cu(NO₃)₄.5H₂O) was spread in a thin film on the back of the sample. The sample was heated to between 50° C. and 60° C. on a hot plate to dry the solution. The sample was annealed for 5 to 20 minutes per sample thickness at 900° C. in muffle furnace and air-quenched to room temperature. The anneal duration was dependent upon the sample thickness. Thinner wafers required a shorter anneal, while thicker wafers required a longer anneal.

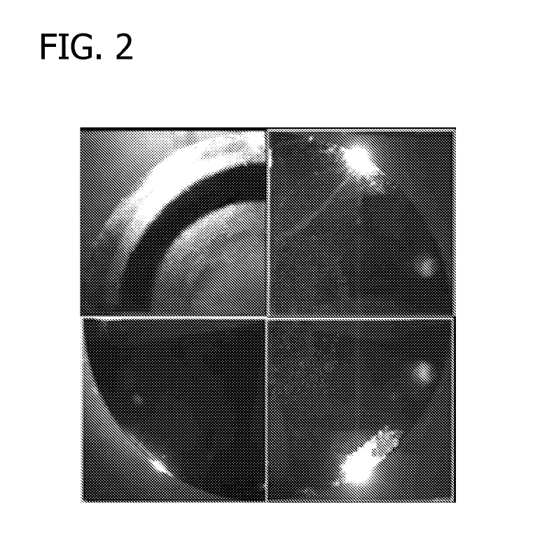

The sample was etched to a mirror finished using mixed acid etchant mixture (57% Nitric Acid (70%), 18% Hydrofluoric Acid (49%) and 25% Hydrochloric Acid), followed by Secco Etch (0.15M Potassium Dichromate and 49% Hydrofluoric Acid, 1:2 ratio). After rinsing and drying, the sample was visually inspected under bright or room light. The sample was also photographed by an optical camera in bright light is used to take picture. The photograph was compared to a scale to quantitatively measure the size and position of crystal defect zone. FIG. 2 is a photograph of four wafer quarters subjected to copper decoration. The wafer quarter shown in the bottom left quadrant of FIG. 2 is a wafer quarter subjected to copper decoration as described in this Example 1. As demonstrated in the wafer quarter shown in the bottom left quadrant of FIG. 2, too few precipitates were delineated to accurately classify the location of the large precipitate region, the small precipitate region, and the P band.

### EXAMPLE b 2

### Copper Decoration of Silicon Wafer

Copper decoration was carried out on a silicon wafer sample. The silicon wafer sample was etched and polished according to conventional techniques. A saturated solution of copper nitrate (Cu(NO₃)₄.5H₂O) was spread in a thin film on the back of the sample. The sample was heated to between 50° C. and 60° C. on a hot plate to dry the solution. The sample was annealed for four hours at 900° C. in muffle furnace and air-quenched to room temperature.

The sample was etched to a mirror finished using mixed acid etchant mixture (57% Nitric Acid (70%), 18% Hydrofluoric Acid (49%) and 25% Hydrochloric Acid), followed by Secco Etch (0.15M Potassium Dichromate and 49% Hydrofluoric Acid, 1:2 ratio). After rinsing and drying, the sample was visually inspected under bright or room light. The sample was also photographed by an optical camera in bright light is used to take picture. The photograph was compared to a scale to quantitatively measure the size and position of crystal defect zone. FIG. 2 is a photograph of four wafer quarters subjected to copper decoration. The wafer quarter shown in the upper left quadrant of FIG. 2 is a wafer quarter subjected to copper decoration as described in this Example 2. As demonstrated in the wafer quarter shown in the upper left quadrant of FIG. 2, too many precipitates were delineated to accurately classify the location of the large precipitate region, the small precipitate region, and the P band.

### EXAMPLE 3

### Copper Decoration of Annealed Silicon Wafer

An etched and polished sample was loaded into a boat and placed in a tube furnace preheated to between 500° C. and 700° C. with 1 slpm oxygen gas environment. The sample was heated to 1100° C. with faster than 7° C./min ramping speed. The sample holding time at high temperature was 10 min in 2 slpm oxygen gas environment. The sample was cooled down faster than 7° C./min to a temperature lower than 500° C.

A saturated solution of copper nitrate (Cu(NO₃)₄.5H₂O) was spread in a thin film on the back of the sample. The sample was heated to between 50° C. and 60° C. on a hot plate to dry the solution. The sample was annealed for 5 to 20 minutes per sample thickness at 900° C. in muffle furnace and air-quenched to room temperature. The anneal temperature was dependent upon the sample thickness. Thinner wafers required a shorter anneal, while thicker wafers required a longer anneal.

The sample was etched to a mirror finished using mixed acid etchant mixture (57% Nitric Acid (70%), 18% Hydrofluoric Acid (49%) and 25% Hydrochloric Acid), followed by Secco Etch (0.15M Potassium Dichromate and 49% Hydrofluoric Acid, 1:2 ratio). After rinsing and drying, the sample was visually inspected under bright or room light. The sample was also photographed by an optical camera in bright light is used to take picture. The photograph was compared to a scale to quantitatively measure the size and position of crystal defect zone. The wafer quarter shown in the upper right quadrant of FIG. 2 is a wafer quarter subjected to copper decoration as described in this Example 2. As demonstrated in the wafer quarter shown in the upper right quadrant of FIG. 2, annealing the wafer sample prior to copper decoration enabled delineation of the large precipitate and small precipitate regions in the Perfect Silicon region of the wafer.

### EXAMPLE 4

### Copper Decoration of Annealed Silicon Wafer

An etched and polished sample was loaded into a boat and placed in a tube furnace pre-heated to between 500° C. and 700° C. with 1 slpm oxygen gas environment. The sample was heated to 1200° C. with faster than 7° C./min ramping speed. The sample holding time at high temperature was 10 min in 2slpm oxygen gas environment. The sample was cooled down faster than 7° C./min to a temperature lower than 500° C.

A saturated solution of copper nitrate (Cu(NO₃)₄.5H₂O) was spread in a thin film on the back of the sample. The sample was heated to between 50° C. and 60° C. on a hot plate to dry the solution. The sample was annealed for 5 to 20 minutes per sample thickness at 900° C. in muffle furnace and air-quenched to room temperature. The anneal temperature was dependent upon the sample thickness. Thinner wafers required a shorter anneal, while thicker wafers required a longer anneal.

The sample was etched to a mirror finished using mixed acid etchant mixture (57% Nitric Acid (70%), 18% Hydrofluoric Acid (49%) and 25% Hydrochloric Acid), followed by Secco Etch (0.15M Potassium Dichromate and 49% Hydrofluoric Acid, 1:2 ratio). After rinsing and drying, the sample was visually inspected under bright or room light. The sample was also photographed by an optical camera in bright light is used to take picture. The photograph was compared to a scale to quantitatively measure the size and position of crystal defect zone. The wafer quarter shown in the bottom right quadrant of FIG. 2 is a wafer quarter subjected to copper decoration as described in this Example 2. As demonstrated in the wafer quarter shown in the bottom right quadrant of FIG. 2, annealing the wafer sample prior to copper decoration enabled delineation of the large precipitate and small precipitate regions in the Perfect Silicon region of the wafer.

### EXAMPLE 5

### Copper Decoration of Annealed Silicon Wafer

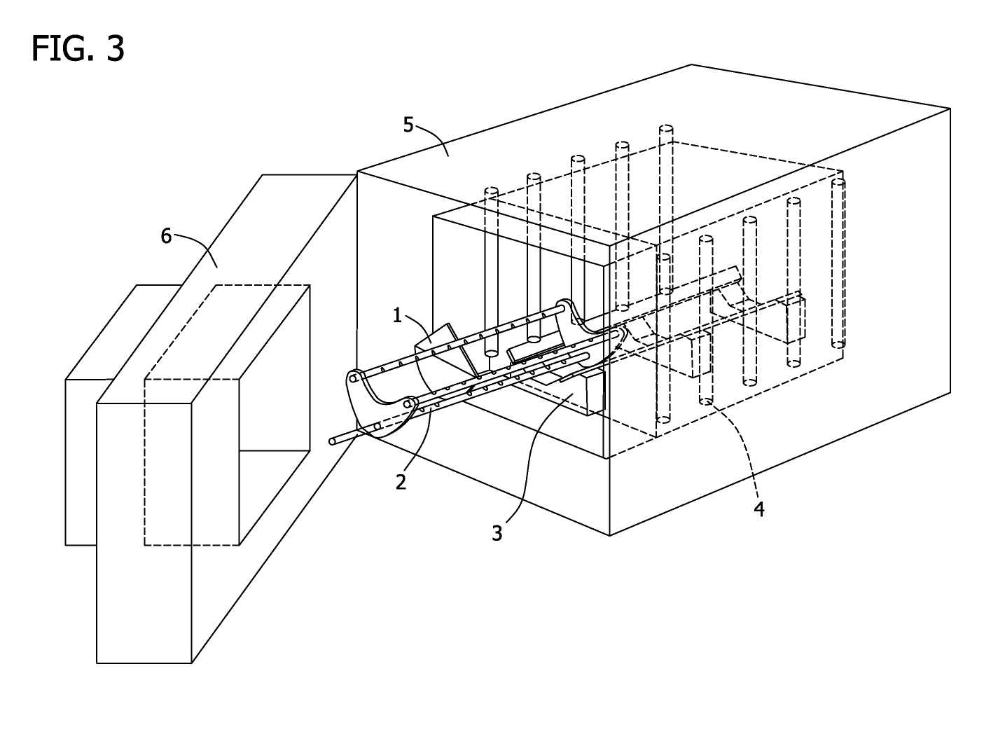

FIG. 3 is a depiction of a muffle furnace with a jig assembly, which was used to anneal a single crystal silicon wafer. The furnace was a user-ordered design and was manufactured by ThermVac Engineering (South Korea). An etched and polished sample (1) was loaded on jig assembly (2) at the outside of furnace. The loaded jig assembly with silicon wafer samples was inserted into the Furnace (5) through support guide (3) which is pre-installed in Furnace. The temperature in the muffle furnace chamber was preheated to between 500° C. to 700° C. The furnace door (6) was closed, and the sample was heated using the heating elements to 1100° C. with faster than 7° C./min ramping speed. The sample holding time at high temperature was 5 min in 2 slpm oxygen gas environment. Then, furnace door was opened, and the jig assembly loaded with the wafer samples was pulled out of chamber rapidly to facilitate rapid cooling at a rate of at least 7° C./min using external handling equipment having speed control unit. An air cooling fan was applied to achieve faster cooling.

A saturated solution of copper nitrate (Cu(NO₃)₄.5H₂O) was spread in a thin film on the back of the sample. The sample was heated to between 50° C. and 60° C. on a hot plate to dry the solution. The sample was annealed for 5 to 20 minutes per sample thickness at 900° C. in muffle furnace and air-quenched to room temperature. The anneal temperature was dependent upon the sample thickness. Thinner wafers required a shorter anneal, while thicker wafers required a longer anneal.

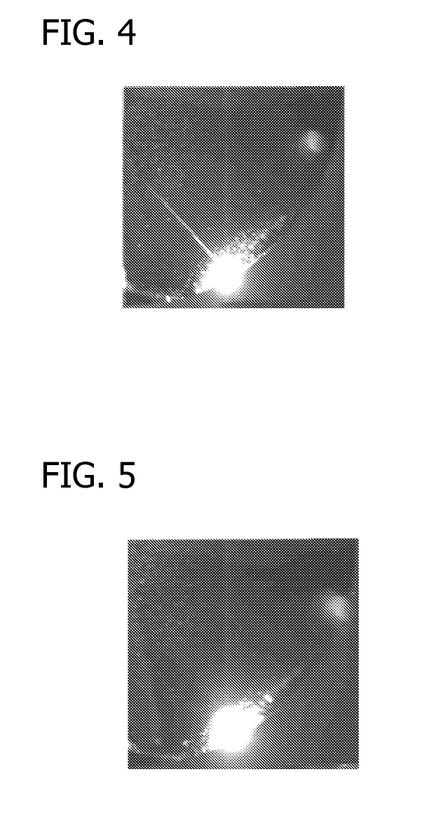

The sample was etched to a mirror finished using mixed acid etchant mixture (57% Nitric Acid (70%), 18% Hydrofluoric Acid (49%) and 25% Hydrochloric Acid), followed by Secco Etch (0.15M Potassium Dichromate and 49% Hydrofluoric Acid, 1:2 ratio). After rinsing and drying, the sample was visually inspected under bright or room light. The sample was also photographed by an optical camera in bright light is used to take picture. The photograph was compared to a scale to quantitatively measure the size and position of crystal defect zone. FIG. 4 is a photograph of a wafer prepared according to this Example.

### EXAMPLE 6

### Copper Decoration of Annealed Silicon Wafer

An etched and polished wafer was loaded on the jig assembly (2) of the muffle furnace depicted in FIG. 3. The loaded jig assembly with silicon wafer samples was inserted into the Furnace (5) through support guide (3) which is pre-installed in Furnace. The temperature in the muffle furnace chamber was preheated to between 500° C. to 700° C. The furnace door (6) was closed, and the sample was heated using the heating elements to 1100° C. with faster than 7° C./min ramping speed. The sample holding time at high temperature was 5 min in 2 slpm oxygen gas environment. Then, furnace door was opened, and the jig assembly loaded with the wafer samples was pulled out of chamber rapidly to facilitate rapid cooling at a rate of at least 10° C./min using external handling equipment having speed control unit. An air cooling fan was applied to achieve faster cooling.

A saturated solution of copper nitrate (Cu(NO₃)₄.5H₂O) was spread in a thin film on the back of the sample. The sample was heated to between 50° C. and 60° C. on a hot plate to dry the solution. The sample was annealed for 5 to 20 minutes per sample thickness at 900° C. in muffle furnace and air-quenched to room temperature. The anneal temperature was dependent upon the sample thickness. Thinner wafers required a shorter anneal, while thicker wafers required a longer anneal.

The sample was etched to a mirror finished using mixed acid etchant mixture (57% Nitric Acid (70%), 18% Hydrofluoric Acid (49%) and 25% Hydrochloric Acid), followed by Secco Etch (0.15M Potassium Dichromate and 49% Hydrofluoric Acid, 1:2 ratio). After rinsing and drying, the sample was visually inspected under bright or room light. The sample was also photographed by an optical camera in bright light is used to take picture. The photograph was compared to a scale to quantitatively measure the size and position of crystal defect zone. FIG. 5 is a photograph of a wafer prepared according to this Example.

### EXAMPLE 7

### Copper Decoration of Annealed Silicon Wafer

An etched and polished sample was loaded into a boat and placed in a tube furnace pre-heated to between 500° C. and 700° C. with 1 slpm oxygen gas environment. The sample was heated to 1100° C. with faster than 7° C./min ramping speed. The sample holding time at high temperature was 5 min in 2 slpm oxygen gas environment. The sample was cooled down faster than 7° C./min to a temperature lower than 500° C.

A saturated solution of copper nitrate (Cu(NO₃)₄.5H₂O) was spread in a thin film on the back of the sample. The sample was heated to between 50° C. and 60° C. on a hot plate to dry the solution. The sample was annealed for 5 to 20 minutes per sample thickness at 900° C. in muffle furnace and air-quenched to room temperature. The anneal temperature was dependent upon the sample thickness. Thinner wafers required a shorter anneal, while thicker wafers required a longer anneal.

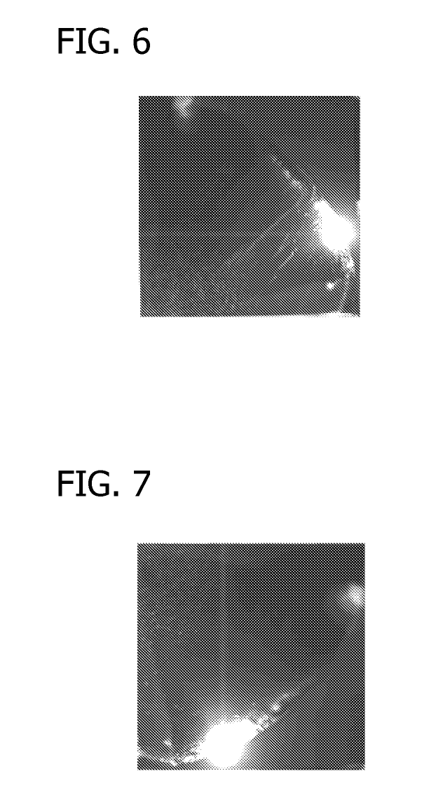

The sample was etched to a mirror finished using mixed acid etchant mixture (57% Nitric Acid (70%), 18% Hydrofluoric Acid (49%) and 25% Hydrochloric Acid), followed by Secco Etch (0.15M Potassium Dichromate and 49% Hydrofluoric Acid, 1:2 ratio). After rinsing and drying, the sample was visually inspected under bright or room light. The sample was also photographed by an optical camera in bright light is used to take picture. The photograph was compared to a scale to quantitatively measure the size and position of crystal defect zone. FIG. 6 is a photograph of a wafer prepared according to this Example.

### EXAMPLE 8

### Copper Decoration of Annealed Silicon Wafer

An etched and polished sample was loaded into a boat and placed in a tube furnace pre-heated to between 500° C. and 700° C. with 1 slpm oxygen gas environment. The sample was heated to 1100° C. with faster than 7° C./min ramping speed. The sample holding time at high temperature was 5 min in 2 slpm oxygen gas environment. The sample was cooled down faster than 10° C./min to a temperature lower than 500° C.

A saturated solution of copper nitrate (Cu(NO₃)₄.5H₂O) was spread in a thin film on the back of the sample. The sample was heated to between 50° C. and 60° C. on a hot plate to dry the solution. The sample was annealed for 5 to 20 minutes per sample thickness at 900° C. in muffle furnace and air-quenched to room temperature. The anneal temperature was dependent upon the sample thickness. Thinner wafers required a shorter anneal, while thicker wafers required a longer anneal.

The sample was etched to a mirror finished using mixed acid etchant mixture (57% Nitric Acid (70%), 18% Hydrofluoric Acid (49%) and 25% Hydrochloric Acid), followed by Secco Etch (0.15M Potassium Dichromate and 49% Hydrofluoric Acid, 1:2 ratio). After rinsing and drying, the sample was visually inspected under bright or room light. The sample was also photographed by an optical camera in bright light is used to take picture. The photograph was compared to a scale to quantitatively measure the size and position of crystal defect zone. FIG. 7 is a photograph of a wafer prepared according to this Example.

### EXAMPLE 9

### Copper Decoration of Annealed Silicon Wafer

An etched and polished sample was loaded into a boat and placed in a tube furnace pre-heated to between 500° C. and 700° C. with 1 slpm oxygen gas environment. The sample was heated to 1100° C. with faster than 7° C./min ramping speed. The sample holding time at high temperature was 10 min in 2 slpm oxygen gas environment. The sample was cooled down faster than 7° C./min to a temperature lower than 500° C.

A saturated solution of copper nitrate (Cu(NO₃)₄.5H₂O) was spread in a thin film on the back of the sample. The sample was heated to between 50° C. and 60° C. on a hot plate to dry the solution. The sample was annealed for 5 to 20 minutes per sample thickness at 900° C. in muffle furnace and air-quenched to room temperature. The anneal temperature was dependent upon the sample thickness. Thinner wafers required a shorter anneal, while thicker wafers required a longer anneal.

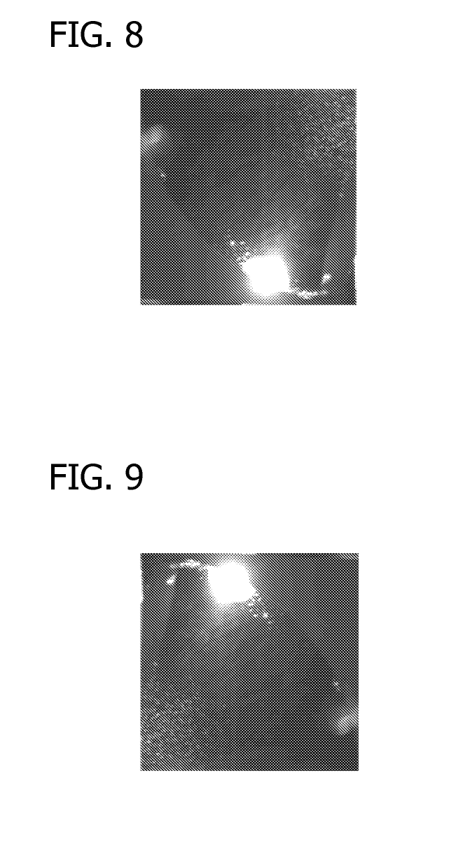

The sample was etched to a mirror finished using mixed acid etchant mixture (57% Nitric Acid (70%), 18% Hydrofluoric Acid (49%) and 25% Hydrochloric Acid), followed by Secco Etch (0.15M Potassium Dichromate and 49% Hydrofluoric Acid, 1:2 ratio). After rinsing and drying, the sample was visually inspected under bright or room light. The sample was also photographed by an optical camera in bright light is used to take picture. The photograph was compared to a scale to quantitatively measure the size and position of crystal defect zone. FIG. 8 is a photograph of a wafer prepared according to this Example.

### EXAMPLE 10

### Copper Decoration of Annealed Silicon Wafer

An etched and polished sample was loaded into a boat and placed in a tube furnace pre-heated to between 500° C. and 700° C. with 1 slpm oxygen gas environment. The sample was heated to 1200° C. with faster than 7° C./min ramping speed. The sample holding time at high temperature was 5 min in 2 slpm oxygen gas environment. The sample was cooled down faster than 7° C./min to a temperature lower than 500° C.

A saturated solution of copper nitrate (Cu(NO₃)₄.5H₂O) was spread in a thin film on the back of the sample. The sample was heated to between 50° C. and 60° C. on a hot plate to dry the solution. The sample was annealed for 5 to 20 minutes per sample thickness at 900° C. in muffle furnace and air-quenched to room temperature. The anneal temperature was dependent upon the sample thickness. Thinner wafers required a shorter anneal, while thicker wafers required a longer anneal.

The sample was etched to a mirror finished using mixed acid etchant mixture (57% Nitric Acid (70%), 18% Hydrofluoric Acid (49%) and 25% Hydrochloric Acid), followed by Secco Etch (0.15M Potassium Dichromate and 49% Hydrofluoric Acid, 1:2 ratio). After rinsing and drying, the sample was visually inspected under bright or room light. The sample was also photographed by an optical camera in bright light is used to take picture. The photograph was compared to a scale to quantitatively measure the size and position of crystal defect zone. FIG. 9 is a photograph of a wafer prepared according to this Example.

### EXAMPLE 11

### Copper Decoration of Annealed Silicon Wafer

An etched and polished sample was loaded into a boat and placed in a tube furnace pre-heated to between 500° C. and 700° C. with 1 slpm oxygen gas environment. The sample was heated to 1200° C. with faster than 7° C./min ramping speed. The sample holding time at high temperature was 10 min in 2 slpm oxygen gas environment. The sample was cooled down faster than 7° C./min to a temperature lower than 500° C.

A saturated solution of copper nitrate (Cu(NO₃)₄.5H₂O) was spread in a thin film on the back of the sample. The sample was heated to between 50° C. and 60° C. on a hot plate to dry the solution. The sample was annealed for 5 to 20 minutes per sample thickness at 900° C. in muffle furnace and air-quenched to room temperature. The anneal temperature was dependent upon the sample thickness. Thinner wafers required a shorter anneal, while thicker wafers required a longer anneal.

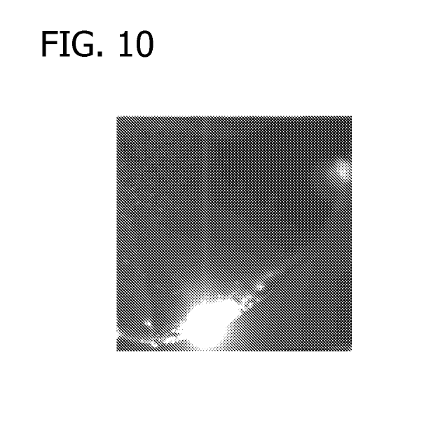

The sample was etched to a mirror finished using mixed acid etchant mixture (57% Nitric Acid (70%), 18% Hydrofluoric Acid (49%) and 25% Hydrochloric Acid), followed by Secco Etch (0.15M Potassium Dichromate and 49% Hydrofluoric Acid, 1:2 ratio). After rinsing and drying, the sample was visually inspected under bright or room light. The sample was also photographed by an optical camera in bright light is used to take picture. The photograph was compared to a scale to quantitatively measure the size and position of crystal defect zone. FIG. 10 is a photograph of a wafer prepared according to this Example.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A process for evaluating oxygen precipitates in a single crystal silicon sample, the process comprising:
(a) annealing the single crystal silicon sample at a temperature sufficient to selectively grow as-grown oxygen precipitates having a size of about 25 nm or more and selectively dissolve as-grown oxygen precipitates having a size of about 25 nm or less;
(b) cooling the single crystal silicon sample at a cooling rate sufficient to inhibit the nucleation of oxygen precipitates having a size of about 25 nm or less;
(c) coating a surface of the single crystal silicon sample with a composition containing a metal capable of decorating oxygen precipitates; and
(d) annealing the coated single crystal silicon sample at a temperature, for a duration, and in an atmosphere sufficient to decorate the oxygen precipitates in the single crystal silicon sample.

2. The process as set forth in claim 1 wherein the single crystal silicon sample comprises a silicon wafer sliced from a single crystal silicon ingot, grown by the Czochralski method.

3. The process as set forth in claim 1 wherein the single crystal silicon sample comprises an oxygen concentration between about 6 ppma and about 13 ppma.

4. The process as set forth in claim 2 wherein the single crystal silicon ingot has a nominal diameter of about 150 mm, about 200 mm, about 300 mm or about 450 mm.

5. The process of claim 1 wherein step (a) comprises annealing at a temperature of at least about 1100° C.

6. The process of claim 5 wherein the single crystal silicon sample is heated from a temperature of less than about 600° C. to the temperature of at least about 1100° C. by heating the sample at a rate of at least about 7° C./minute.

7. The process of claim 1 wherein step (a) comprises annealing at a temperature of at least about 1200° C.

8. The process of claim 7 wherein the single crystal silicon sample is heated from a temperature of less than about 600° C. to the temperature of at least about 1200° C. by heating the sample at a rate of at least about 7° C./minute.

9. The process of claim 1 wherein step (a) comprises annealing for a duration of at least about 300 seconds, or between about 300 seconds and about 20 minutes.

10. The process of claim 1 wherein step (a) comprises annealing in an atmosphere comprising oxygen, argon, or a combination thereof.

11. The process of claim 1 wherein step (b) comprises cooling from a temperature of at least about 1100° C. to a temperature of less than about 600° C. at a rate of at least about 7° C./minute.

12. The process of claim 1 wherein step (b) comprises cooling from a temperature of at least about 1200° C. to a temperature of less than about 500° C. at a rate of at least about 7° C./minute.

13. The process of claim 1 wherein the metal is copper.

14. The process of claim 13 wherein the copper is present in an aqueous solution saturated with copper nitrate.

15. The process as set forth in claim 1 wherein step (d) comprises annealing at a temperature of at least about 900° C.

16. The process as set forth in claim 15 wherein step (d) comprises annealing for at least about 300 seconds, or between about 300 seconds and about 20 minutes.

17. The process of claim 1 further comprising:
(e) cooling the coated single crystal silicon sample comprising decorated agglomerated intrinsic point defects;
(f) etching the surface of the cooled single crystal silicon sample comprising decorated oxygen precipitates with a first etchant to remove residues and precipitants without delineating the decorated oxygen precipitates; and
(g) etching the etched surface with a delineating etchant to reveal the decorated oxygen precipitates.

18. The process as set forth in claim 17 further comprising (h) visually inspecting the etched surface for the presence of decorated oxygen precipitates.

19. The process of claim 17 wherein the non-defect delineating etch is a bright etch solution or a mixed acid etch solution.

20. The process of claim 19 wherein the non-defect delineating etch is a bright etch solution comprising nitric acid, hydrofluoric acid, and hydrochloric acid.

21. The process of claim 19 wherein the non-defect delineating etch is a bright etch solution comprising about 57 percent nitric acid (70% solution by weight), about 18 percent hydrofluoric acid (49% solution by weight), and about 25 percent hydrochloric acid (concentrated solution).

22. The process of claim 5 wherein the defect delineating etch comprises treating the sample with a Secco etch solution.

23. The process of claim 22 wherein the Secco etch solution comprises about a 1:2 ratio of 0.15 M potassium dichromate and hydrofluoric acid (49% solution by weight).
